(19) United States
(12) Patent Application Publication
(10) Pub. No.: US 2024/0312669 A1
(43) Pub. Date: Sep. 19, 2024

(54) INSULATED ELECTRIC WIRE AND WIRE HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Yoshitaka YAMADA, Yokkaichi-shi (JP); Kyoma SAHASHI, Yokkaichi-shi (JP); Toyoki FURUKAWA, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 18/281,757

(22) PCT Filed: Mar. 25, 2022
(86) PCT No.: PCT/JP2022/014294

§ 371 Date: Sep. 12, 2023

(30) Foreign Application Priority Data
Mar. 31, 2021 (JP) 2021-060354
Oct. 13, 2021 (JP) 2021-168394

(51) Int. Cl. H01B 7/08; H01B 13/00; H01B 13/14

(52) U.S. Cl. CPC H01B 7/08; H01B 13/0006; H01B 13/148

(57) ABSTRACT

An insulated electric wire capable of performing processing including removal of an insulation coating while having a flat portion in which a cross-section of a conductor has a flat outer shape, and a wiring harness having such an insulated electric wire are provided. The insulated electric wire has a conductor including a plurality of elemental wires, and an insulation coating covering an outer periphery of the conductor, having, in a cross-section perpendicular to the axial direction, a flat outer shape in the flat portion and a less flat outer shape in the low-flatness portion than in the flat portion in the insulated electric wire, and the insulated electric wire has an adhesive force between the conductor and the insulation coating which is smaller in the low-flatness portion than in the flat portion.

### TECHNICAL FIELD

The present disclosure relates to an insulated electric wire and a wiring harness.

### BACKGROUND ART

A flat cable containing a flat-shaped conductor has been known. A flat cable occupies a smaller space for routing than a conventional electric wire including a conductor having a substantially circular cross-section.

In a conventional flat cable, a flat rectangular conductor is often used as a conductor as disclosed in Patent Literatures 1 and 2, etc. The flat rectangular conductor is made of a single metal wire formed to have a rectangular cross-section. Further, Patent Literatures 3 to 5 applied by the present applicants, disclose an electric wire conductor in which a twisted wire obtained by twisting a plurality of elementary wires together is made into a flat outer shape from the viewpoint of achieving both flexibility and space-saving property.

### CITATION LIST

### Patent Literature

PTL1: JP 2014-130739 A
PTL2: JP 2019-149242 A
PTL3: WO 2019/093309
PTL4: WO 2019/093310
PTL5: WO 2019/177016

### SUMMARY OF INVENTION

### Technical Problem

As disclosed in Patent Literatures 3 to 5, a flat electric wire provided with a conductor obtained by forming a plurality of elemental wires twisted together into a flat outer shape is excellent in both space-saving property and flexibility. However, to such flat electric wire, it is impossible to apply tools such as a wire stripper for removing the insulation coating, or terminals for attachment to end portions, which have been used for an electric wire having a generally circular cross-section (round electric wire), without any change. Further, the flat electric wire tends to have high adhesion between the insulation coating and the conductor due to a large surface area of the conductor as compared with the round electric wire having the same conductor cross-sectional area. Then, a large force is required to remove the insulation coating from the terminal portion of the flat electric wire in order to perform the attachment of a terminal or the like. Thus, it may be difficult to perform processing of the terminal portion of the flat electric wire or the like, which includes removal of the insulation coating.

In view of the above, an object is to provide an insulated electric wire capable of easily performing processing with removal of an insulation coating while having a flat portion with a flat cross-section of a conductor, and a wiring harness having such an insulated electric wire.

### Solution to Problem

An insulated electric wire according to a first form of the present disclosure, includes a conductor having a plurality of elemental wires twisted together, and an insulation coating covering an outer periphery of the conductor, wherein the insulated electric wire includes a flat portion and a low-flatness portion along an axial direction of the insulated electric wire, where the plurality of elemental wires constituting the conductor and the insulation coating are each continuous through these portions; the conductor has, in a cross-section perpendicular to the axial direction, a flat outer shape in the flat portion and a less flat outer shape in the low-flatness portion than in the flat portion in the insulated electric wire; and the insulated electric wire has an adhesive force between the conductor and the insulation coating which is smaller in the low-flatness portion than in the flat portion.

An insulated electric wire according to a second form of the present disclosure is manufactured by the steps of: making an insulated electric wire by compressing a conductor in which a plurality of elemental wires are twisted together into a flat outer shape and by covering an outer periphery of the conductor with an insulation coating; thereafter forming a low-flatness portion by applying a force to the insulated electric wire from outside to inside in a width direction of the flat outer shape in a partial region along an axial direction of the insulated electric wire to reduce the degree of flatness of the conductor; and leaving a region other than the partial region formed into the low-flatness portion as a flat portion.

An insulated electric wire according to a third form of the present disclosure is manufactured by the steps of: making an insulated electric wire by covering an outer periphery of the conductor in which a plurality of elemental wires are twisted together with an insulation coating; thereafter forming a flat portion by applying a force for compression to the insulated electric wire from directions facing each other in a partial region along an axial direction of the insulated electric wire to increase the degree of flatness of the conductor; and leaving the region other than the partial region formed into the flat portion as a low-flatness portion.

A wiring harness of the present disclosure includes the insulated electric wire.

### Advantageous Effects of Invention

An insulated electric wire and a wiring harness according to the present disclosure are an insulated electric wire capable of simply performing processing including removal of an insulation coating while having a flat portion in which the cross-section of a conductor has a flat outer shape, and a wiring harness including such an insulated electric wire.

### BRIEF DESCRIPTION OF DRAWINGS

FIG. 1 FIGS. 1A to 1C are schematic views showing an insulated electric wire according to an embodiment of the present disclosure, in which FIG. 1A is a perspective view of the insulated electric wire, FIG. 1B is a flat portion corresponding to a cross-section taken along line A-A in FIG. 1A, FIG. 1C is a cross-sectional view showing a low-flatness portion corresponding to a cross-section taken along line B-B in FIG. 1A, and in each figure, elemental wires that constitute a conductor are omitted.

FIGS. 2A and 2B are cross-sectional views respectively showing a flat portion and a low-flatness portion of the insulated electric wire according to the embodiment.

FIG. 3 is a schematic view showing an insulated electric wire having a plurality of regions different in flat direction as flat portions, in which FIG. 3A is a perspective view of the insulated electric wire, FIG. 3B is a cross-sectional view showing a first region corresponding to a cross-section taken along line C-C in FIG. 3A and a third region corresponding to a cross-section taken along line E-E in FIG. 3A, FIG. 3C is a cross-sectional view showing a second region corresponding to a cross-section taken along line D-D in FIG. 3A, and in each figure, elemental wires that constitute a conductor are omitted.

FIG. 4 is a diagram describing a method for manufacturing an insulated electric wire according to an embodiment of the present disclosure, taking the insulated electric wire shown in FIG. 1 as an example.

FIG. 5 is a diagram describing a method for manufacturing an insulated electric wire according to another embodiment of the present disclosure.

FIGS. 6A and 6B are tables summarizing cross-sectional images and various evaluation results for a flat portion and a low-flatness portion of “Sample 1” and “Sample 2”, respectively.

### DESCRIPTION OF EMBODIMENTS

### Description of Embodiments of the Present Disclosure

First, the embodiments of the present disclosure will be listed and described.

An insulated electric wire according to a first form of the present disclosure, includes a conductor having a plurality of elemental wires twisted together; and an insulation coating covering an outer periphery of the conductor, wherein the insulated electric wire includes a flat portion and a low-flatness portion along an axial direction of the insulated electric wire, where the plurality of elemental wires constituting the conductor and the insulation coating are each continuous through these portions; the conductor has, in a cross-section perpendicular to the axial direction, a flat outer shape in the flat portion and a less flat outer shape in the low-flatness portion than in the flat portion in the insulated electric wire; and the insulated electric wire has an adhesive force between the conductor and the insulation coating which is smaller in the low-flatness portion than in the flat portion.

The insulated electric wire has in succession, the flat portion in which the conductor is formed into the flat outer shape and the low-flatness portion having the less flat outer shape. Compared to the flat portion, the low-flatness portion is similar in cross-sectional shape to a conventional general round electric wire. Therefore, when performing processing such as removal of an insulation coating and attachment of external members starting with terminals, etc., if such processing is performed on the low-flatness portion, it is easy to apply tools such as a wire stripper for removing the insulation coating or external members such as terminals, which have been generally used for round electric wires. Further, since the adhesive force between the conductor and the insulation coating is smaller in the low-flatness portion than in the flat portion, the insulation coating can be removed with a small force in the low-flatness portion. Thus, by performing processing on the low-flatness portion while obtaining the effect of improving space saving by the flat portion, it is possible to easily perform processing of the insulated electric wire including the removal of the insulation coating. In the flat portion, the insulation coating is adhered to the conductor with a large adhesive force. Therefore, even if the adhesive force is small in the low-flatness portion, it is possible to suppress the occurrence of a positional deviation between the insulation coating and the conductor for the insulated electric wire as a whole, and also to ensure heat dissipation from the conductor through the insulation coating during energization.

Thus, the insulated wire having both the flat portion and the low-flatness portion and having a low adhesion between the conductor and the insulation coating in the low-flatness portion can be easily manufactured by a method of: making a flat electric wire by covering an outer periphery of the conductor having the flat outer shape with an insulation coating; thereafter forming the low-flatness portion by applying a force for compression to the conductor from outside in the width direction of the flat shape in a partial region of the flat electric wire so as to deform the conductor to reduce the degree of flatness of the conductor. Alternatively, such an insulated electric wire can be easily manufactured even by a method of: making a low-flatness electric wire having a conductor low in the degree of flatness, such as a round electric wire by covering the outer periphery of the conductor with the insulation coating; thereafter forming the flat portion by applying a force for compression to the low-flatness electric wire from directions facing each other in a partial region of the low-flatness electric wire to increase the degree of flatness of the conductor.

Here, it is preferable that the adhesive force between the conductor and the insulation coating is 20% or smaller in the low-flatness portion than in the flat portion. Then, the insulation coating can be removed particularly easily in the low-flatness portion.

It is preferable that the low-flatness portion has a vacancy ratio higher than the flat portion, the vacancy ratio defined as a ratio of vacancies not occupied by the elemental wires in an area surrounded by an inner periphery of the insulation coating in the cross-section of the insulated electric wire. Further, the vacancies formed between the conductor and the insulation coating as mentioned above, and the vacancies formed between the elemental wires constituting the conductor enhance the flexibility of the low-flatness portion. Therefore, since the ratio of vacancies of the low-flatness portion is higher than the flat portion, it is possible to effectively enhance the easiness of peeling and flexibility of the insulation coating in the low-flatness portion. The insulated electric wire in which the low-flatness portion is higher in ratio of vacancies than the flat portion is easily manufactured by a form in which the force is applied to the flat electric wire to form the low-flatness portion.

In this case, it is preferable that the ratio of vacancies in the cross-section is 20% or higher in the low-flatness portion than in the flat portion. Consequently, the easiness of peeling and the flexibility of the low-flatness portion can be particularly effectively enhanced.

It is preferable that, defining a region outside the conductor in the cross-section of the low-flatness portion along directions corresponding to the width direction and the height direction of the flat outer shape as a width-directional conductor-outside region and a height-directional conductor-outside region, respectively, and the insulated electric wire has a larger vacancy between the conductor and the insulation coating in the width-directional conductor-outside region than in the height-directional conductor-outside region. As described above, the vacancy formed between the conductor and the insulation coating reduces the adhesive force between the conductor and the insulation coating. When the force is applied to the flat electric wire from the outside in the width direction to form the low-flatness portion, the vacancies are likely to be formed between the conductor and the insulation coating in the region outside the conductor in the width direction as the dimensions of the conductor in the width direction become smaller.

It is preferable that difference in length of the inner periphery of the insulation coating between the flat portion and the low-flatness portion is within 5% of the length of the inner periphery of the insulation coating in the flat portion. When the flat electric wire is deformed by applying the force thereto to form the low-flatness portion, a change in the length of the inner circumference of the insulation coating is restricted by the inner peripheral surface of the insulation coating. Therefore, simple manufacturing can be achieved for the insulated electric wire in which the difference in the length of the inner circumference of the insulation coating between the flat portion and the low-flatness portion is suppressed to 5% or less of the length of the inner circumference of the insulation coating in the flat portion, with the flat electric wire as a base-material.

The insulated electric wire may have a plurality of regions having flat shapes oriented in mutually different directions, as the flat portion. The flat portion exhibits high flexibility in bending in the height direction of the flat outer shape. Therefore, if the insulated electric wire is provided with the flat portion having a plurality of regions whose flat shapes are oriented in mutually different directions, each region is easily bent in the height direction of each flat outer shape, so that a single insulated electric wire can have a plurality of portions with different bending directions. For example, where the insulated electric wire needs to be bent into a complicated shape such as for three-dimensional routing, by setting a plurality of regions to form a flat portion such that the height direction of the flat outer shape faces a direction desired to bend for each portion of the insulated electric wire, it is possible to bend the electric wire without difficulty even if it has a complicated shape.

The insulated electric wire preferably has the low-flatness portion on at least one side of the flat portion along the axial direction. An insulated electric wire provided with a low-flatness portion on at least one side of the flat electric wire, a terminal portion, for example, can make use of the low-flatness portion while taking advantage of the space saving property of the flat portion for routing, whereby removal of the insulation coating and processing such as attachment of a terminal and a connector, etc. can be easily performed. By performing the processing on the low-flatness portion having a cross-sectional shape with low degree of flatness, there is no need to use a flat terminal or connector that match the shape of the flat portion.

The insulated electric wire according to a second form of the present disclosure is manufactured by steps of: making an insulated electric wire by compressing a conductor in which a plurality of elemental wires are twisted together into a flat outer shape and by covering an outer periphery of the conductor with an insulation coating; thereafter forming a low-flatness portion by applying a force to the insulated electric wire from outside to inside in a width direction of the flat outer shape in a partial region along an axial direction of the insulated electric wire to reduce the degree of flatness of the conductor; and leaving a region other than the partial region formed into the low-flatness portion as a flat portion.

In the insulated electric wire according to the second form, the flat electric wire in which the conductor having the flat outer shape is covered with an insulation coating is subjected to an operation of compressing the conductor by applying the force from the outside in the width direction, so that the adhesive force between the conductor and the insulation coating becomes smaller in the low-flatness portion. Therefore, in the low-flatness portion, it becomes easier to perform processing including removal of the insulation coating in combination with the effect of the low flatness itself. Therefore, the insulated electric wire becomes an insulated electric wire excellent in both the space saving property due to the flat portion and easiness of processing in the low-flatness portion. Further, due to the operation of applying the force to the flat electric wire from the outside in the width direction to compress the conductor, the vacancies not occupied by the elemental wires are likely to be formed in the region inside the insulation coating in the low-flatness portion. Such vacancies are highly effective in reducing the adhesive force between the conductor and the insulation coating and improving flexibility in the low-flatness portion.

The insulated electric wire according to a third form of the present disclosure is manufactured by the steps of: making an insulated electric wire by covering an outer periphery of the conductor in which a plurality of elemental wires are twisted together with an insulation coating; thereafter forming a flat portion by applying a force for compression to the insulated electric wire from directions facing each other in a partial region along an axial direction of the insulated electric wire to increase the degree of flatness of the conductor; and leaving a region other than the partial region formed into the flat portion as a low-flatness portion.

The insulated electric wire according to the third form also is the insulated electric wire in which the adhesive force between the conductor and the insulation coating is smaller in the low-flatness portion than in the flat portion, corresponding to an operation that the insulated electric wire low in the degree of flatness is subjected to be compressed from directions facing each other. Therefore, in the low-flatness portion, it becomes easier to perform processing including removal of the insulation coating in combination with the effect of the low flatness itself. Therefore, the insulated electric wire becomes an insulated electric wire excellent in both the space saving property due to the flat portion and easiness of processing in the low-flatness portion. By applying the force to the insulated electric wire having a conductor low in the degree of flatness, such as a round electric wire to deform it to form a flat portion, an insulated electric wire that integrates a low-flatness portion and a flat portion can be easily formed with a commonly-used insulated electric wire as a base-material.

A wiring harness according to the present disclosure includes the insulated electric wire according to the present disclosure. As described above, in the insulated electric wire according to the present disclosure, the flat portion exhibits a high space saving property and flexibility, and in the low-flatness portion, processing including the removal of the insulation coating can be easily performed. The wiring harness as a whole can also be suitably used for applications such as a connection between devices in portions where space is limited, such as in automobiles, by taking advantages of those characteristics.

### Details of Embodiments of Present Disclosure

An insulated electric wire and a wiring harness according to an embodiment of the present disclosure will hereinafter be described in detail with reference to the drawings. In the present specification, regarding the shape of each part of the insulated electric wire, the concepts indicating the shape and arrangement of a member, such as straight, parallel, and vertical include errors from the geometrical concept within the range allowable for this type of insulated electric wire, such as deviations of approximately ±15% or so in length and approximately ±150 or so in angle. In the present specification, unless otherwise specified, the cross-section of an insulated electric wire or a conductor indicates a cross-section cut perpendicularly to the axial direction (longitudinal direction).

### <Overview of Insulated Electric Wire>

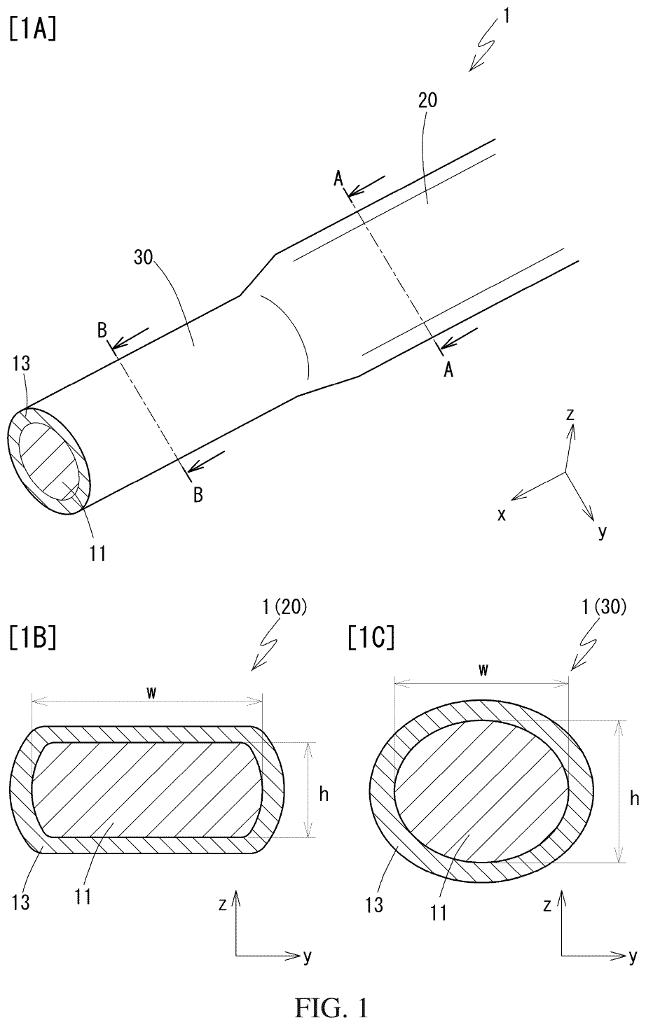

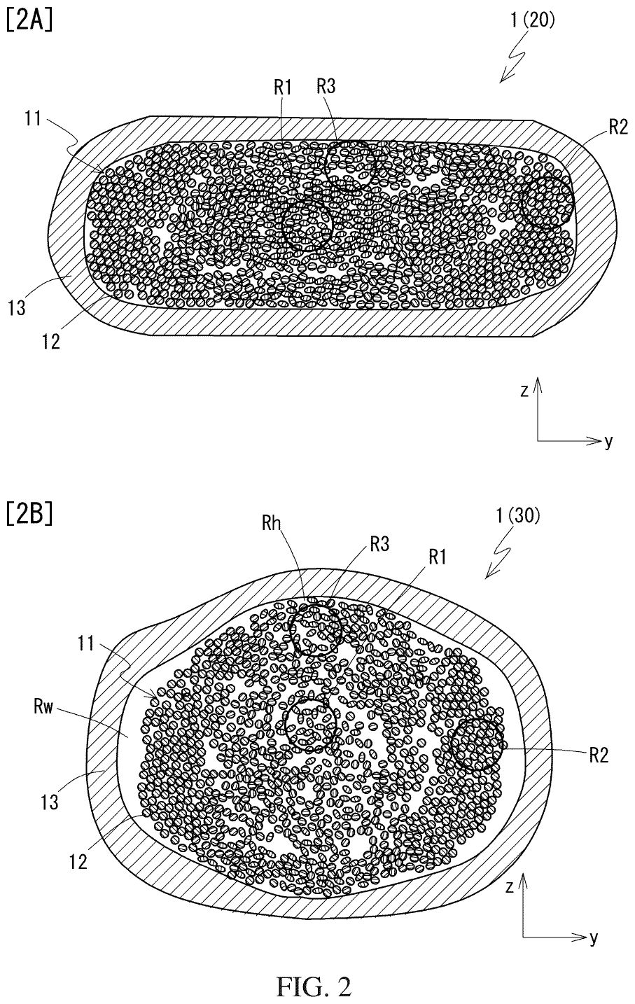

FIG. 1A shows in a perspective view, an insulated electric wire 1 according to one embodiment of the present disclosure. Also, FIGS. 1B and 1C show in a simplified form, cross-sectional views cut along lines A-A and B-B in FIG. 1A, respectively. Further, FIGS. 2A and 2B show in detail, cross-sections of a flat portion corresponding to FIG. 1B and a low-flatness portion corresponding to FIG. 1C, respectively.

The insulated electric wire 1 according to the present embodiment has a conductor 11 and an insulation coating 13. The conductor 11 includes a twisted wire in which a plurality of elemental wires 12 are twisted together. The insulation coating 13 covers the outer periphery of the conductor 11 over the entire circumference. The insulated electric wire 1 has a flat portion 20 and a low-flatness portion 30 along an axial direction (x direction). The flat portion 20 and the low-flatness portion 30 are integrally continuous along the axial direction of the insulated electric wire 1. That is, the elemental wires 12 forming the conductor 11 are each integrally continuous with each other through the flat portion 20 and the low-flatness portion 30. Further, the insulation coating 13 that covers the conductor 11 is also integrally continuous through the flat portion 20 and the low-flatness portion 30.

In the flat portion 20, the outer shape of the conductor 11 in the cross-section has a flat shape. Here, the fact that the outer shape of the conductor 11 has the flat shape means that the length of the longest straight line among the straight lines that cross the cross-section parallel to the sides or diameters that form the cross-section and that covers the entire cross-section. The conductor may have any specific shape as long as the cross-section of the conductor 11 is flat in shape, but in the present embodiment, the cross-section of the conductor 11 has a shape that can approximate to a rectangle. Flat outer shapes other than the rectangle include, for example, elliptical, oblong, and oval shapes (shapes in which circular arcs are joined to both ends of a rectangle). From the viewpoint of enhancing space saving and enhancing continuity with the low-flatness portion 30, etc., the aspect ratio w/h of the flat portion 20 is preferably about 2 or more and 6 or less, for example. Subsequently, in the entire region of the insulated electric wire 1 including the low-flatness portion 30, the directions corresponding to the width direction and the height direction of the flat outer shape of the flat portion 20 are referred to as a width equivalent direction (y direction) and a height equivalent direction (z direction), respectively.

The low-flatness portion 30 has a shape lower in degree of flatness in the conductor 11 than the flat portion 20 in the cross-section of the low-flatness portion 30. Here, the low degree of flatness of the conductor 11 means that the cross-sectional aspect ratio w/h of the conductor 11 is small and the flatness of the cross-sectional shape is low. The specific shape of the low-flatness portion 30 is not particularly limited. A shape that can be approximated to a rectangle, ellipse, or oval or the like lower in the aspect ratio w/h than the flat portion 20 can be exemplified in addition to shapes that can be approximated to graphic forms having no anisotropy or low in anisotropy, such as a square, a circular shape, a hexagon, etc. It is particularly preferable that the degree of flatness of the low-flatness portion 30 is as small as possible, and a form having a shape that can be approximated to a circular shape or a square, in which the aspect ratio w/h becomes 1 is particularly preferable. Further, a form that can be approximated to the circular shape in cross-section is most preferable. However, if the aspect ratio w/h of the low-flatness portion 30 is set to 2 or less, for example, the effect of enhancing the workability of the low-flatness portion 30 to be described later can be sufficiently obtained. Also, the aspect ratio w/h of the low-flatness portion 30 may be set to approximately 20% or more or 70% or less of the aspect ratio w/h of the flat portion 20. In the low-flatness portion 30, it is preferable that the dimension w in the width equivalent direction is not set smaller than the dimension h in the height equivalent direction (preferably w/h≥1). That is, it is preferable that the low-flatness portion 30 does not have a vertically long cross-sectional shape. However, the low-flatness portion 30 is not precluded from having a vertically long cross-sectional shape. In that case, it is preferable to set the aspect ratio h/w of the low-flatness portion 30 lower than the aspect ratio w/h of the flat portion 20. Further, from the viewpoint of improving the workability of the low-flatness portion 30, it is sufficient to set the aspect ratio h/w of the low-flatness portion 30 to be 2 or less, like the aspect ratio w/h in the case of the horizontally long shape described above. Also, the aspect ratio h/w of the low-flatness portion 30 may be approximately 20% or more and 70% or less of the aspect ratio w/h of the flat portion 20.

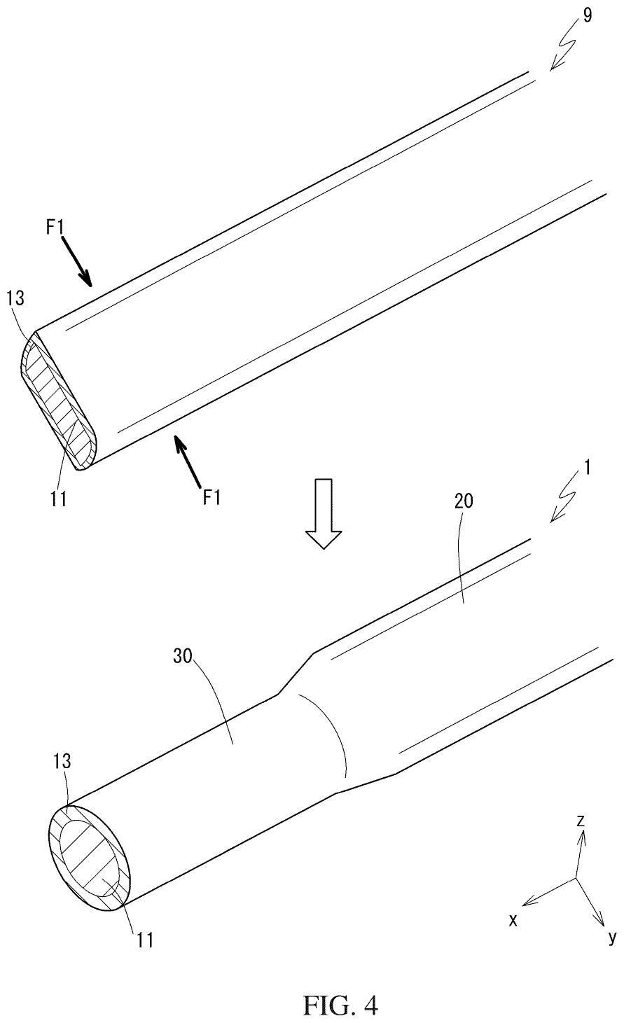

Thus, as shown in FIG. 4, the insulated electric wire 1 integrally having the flat portion 20 and the low-flatness portion 30 can be suitably manufactured from a base-material flat electric wire 9 obtained by deforming the conductor 11 into a flat outer shape. The base-material flat electric wire 9 can be manufactured by compressing a conductor 11 having a circular cross-section in which a plurality of elemental wires 12 are twisted together into a flat outer shape and covering the outer periphery of the conductor 11 with an insulation coating 13. At this time, as described in Patent literatures 3 to 5, the compression of the conductor 11 can be suitably performed by compression from both sides in the height direction and optionally from both sides in the width direction using a roller. The formation of the insulation coating 13 on the outer periphery of the compressed conductor 11 is preferably performed by extrusion molding of a resin composition. In a partial region along the axial direction, specifically, a region where it is desired to form the low-flatness portion 30, of the base-material flat electric wire 9 obtained in this manner, a force F1 is applied from outside to inside along the width direction (y direction) from the outside of the base-material flat electric wire 9 to deform the conductor 11. The application of the force F1 reduces the dimension of the conductor 11 in the width direction and reduces the degree of flatness of the conductor 11. With this operation, the low-flatness portion 30 can be formed. The application of the force F1 can be performed by manual processing, or processing using a tool such as a hammer, or a device such as a molding die, a press machine, or the like. The force F1 applied to the conductor 11 at this time is preferably smaller than the force applied for flattering the conductor 11 when forming the base-material flat electric wire 9. In the base-material flat electric wire 9, the region other than the region where the low-flatness portion 30 is formed by the application of the force F1 is left as the flat portion 20.

After forming the low-flatness portion 30 by application of the force F1, it is also conceivable to heat the insulation coating 13 at a portion including the low-flatness portion 30 to bring the insulation coating 13 into close contact with the conductor 11. However, it is preferable not to do such operations. This is to keep an adhesive force between the conductor 11 and the insulation coating 13 small and leave many gaps in the region surrounded by the insulation coating 13 in the low-flatness portion 30, as will be described later. However, a gap may be arranged at a desired portion between the conductor 11 and the insulation coating 13 by heating the insulation coating 13 at a portion including the low-flatness portion 30 to deform the insulation coating 13. For example, when the low-flatness portion 30 has a vertically long cross-sectional shape (w/h<1), there is considered a form to deform the insulation coating 13 such that the gaps are unevenly distributed in a region outside the conductor 11 in the height equivalent direction, that is, outside in the longitudinal direction.

The insulated electric wire 1 according to the present embodiment is provided with the flat portion 20 having the flat cross-sectional shape. Therefore, the insulated electric wire 1 exhibits a high space saving property and can also be suitably used for routing in a narrow space or routing in a state close to other members. On the other hand, since the low-flatness portion 30 has a cross-sectional shape low in the degree of flatness and has a cross-sectional shape close to that in a conventional general round electric wire, it tends to be easy to perform processing such as removal of the insulation coating 13 from the low-flatness portion 30 by using tools and devices such as wire strippers which are applied to the conventional round electric wires. Also, it tends to be easy to apply conventional ones for round electric wires also as external members such as terminals and connectors to be attached to the insulated electric wire 1 without preparing ones of special shapes that match the flat outer shape. By processing the insulated electric wire 1 using the low-flatness portion 30 in this way, processing such as removal of the insulation coating 13 can be easily performed. The insulated electric wire 1 according to the present embodiment can suitably be applied to portions where space that can be arranged for routing such as in cars is limited, and processing including removal of the insulation coating 13 is required for connection with external members.

In the present embodiment, in the axial direction of the insulated electric wire 1, the position and number of the low-flatness portions 30 to be arranged are not particularly limited, and the low-flatness portion 30 may be formed at an arbitrary portion where processing such as removal of the insulation coating 13 is expected. As described above, since the low-flatness portion 30 can be formed only by applying the force F1 that deforms the conductor 11 from the outside of the insulation coating 13 to the base-material flat electric wire 9, various insulated electric wires 1 having different portions where the low-flatness portion 30 is required can be easily manufactured using the common base-material flat electric wire 9. A preferred form may include a form having the low-flatness portions 30 on at least one side or both sides of the flat portion 20 along the axial direction of the insulated electric wire 1. Further, a form is preferable in which the low-flatness portion 30 is formed at least at one end or both ends of one insulated electric wire 1, and the remaining region such as the middle region of the insulated electric wire 1 sandwiched between the two low-flatness portions 30 is taken as the flat portion 20. Then, when routing the insulated electric wire 1, the space-saving property of the flat portion 20 can be used for routing in the middle region, etc., and from the viewpoint of the convenience of connection with external members, etc., the low-flatness portion 30 is provided at least at one of the ends of the insulated electric wire 1 in the case where it is more convenient to provide the low-flatness portion 30 than the flat portion 20, so that processing necessary for connection with the external members such as terminals and connectors can be easily performed starting with the removal of the insulation coating 13.

In the insulated electric wire 1 according to the present embodiment, the material and wire diameter of each elemental wire 12 constituting the conductor 11, and the cross-sectional area of the conductor 11 are not limited in particular. It is however preferable to use the conductor 11 having a conductor cross-sectional area large in some measure from the viewpoint of enhancing the effect of a space-saving improvement by the flat portion 20 and the effect of a workability improvement by the provision of the low-flatness portion 30. From this point of view, as the material of the conductor 11, it is preferable to use aluminum or an aluminum alloy that often makes the cross-sectional area of the conductor large because it is low in conductivity compared to copper and a copper alloy. Further, the cross-sectional area of the conductor is preferably 10 mm² or more, more preferably 50 mm² or more or 100 mm² or more. As the outer diameter of the elemental wire 12 constituting the conductor 11, a range of 0.3 mm or more and 1.0 mm or less can be exemplified.

The insulated electric wire 1 according to the present embodiment may be used in a single state or may be used as a constituent member of the wiring harness according to the embodiment of the present disclosure. The wiring harness according to the embodiment of the present disclosure includes the insulated electric wire 1 according to the above embodiment. The wiring harness may include a plurality of the insulated electric wires 1 described above, or may include other types of insulated electric wires in addition to the insulated electric wires 1 described above. In the wiring harness including the plurality of insulated electric wires, the plural insulated electric wires are often connected to a common connector at its terminal portion. In this case, if the terminal includes a flat outer shape as the insulated electric wire, the entire connector becomes wider to match the flat outer shape, and a large space may be required for the arrangement of the connector. However, if the wiring harness is prepared to use the insulated electric wire 1 according to the present embodiment in which the low-flatness portion 30 is formed at the terminal portion, it is possible to avoid excessive widening of the connector.

### <Comparison Between Flat Portion and Low-Flatness Portion>

The flat portion 20 and the low-flatness portion 30 of the insulated electric wire 1 according to the present embodiment have differences in structure and characteristics in addition to the difference in degree of flatness in the cross-sectional shape of the conductor 11.

### (1) Adhesive Force Between Conductor and Insulation Coating

In the insulated electric wire 1 according to the present embodiment, the adhesive force between the conductor 11 and the insulation coating 13 is smaller in the low-flatness portion 30 than in the flat portion 20. Since the flat portion 20 is large in surface area due to its flat outer shape, the flat portion 20 comes into contact with the insulation coating 13 over a large area. Therefore, the adhesive force per unit length along the axial direction becomes large between the conductor 11 and the insulation coating 13. However, since the degree of flatness of the cross-sectional shape is low in the low-flatness portion 30, the surface area of the conductor becomes smaller than the flat portion 20 having the same conductor cross-sectional area, and the contact area with the insulation coating 13 becomes smaller. Therefore, in the low-flatness portion 30, the adhesive force per unit length along the axial direction becomes smaller than the flat portion 20 between the conductor 11 and the insulation coating 13.

Further, when the base-material flat electric wire 9 is deformed to form the low-flatness portion 30, the adhesive force between the conductor 11 and the insulation coating 13 in the low-flatness portion 30 is particularly likely to become small. In the flat portion 20, the base-material flat electric wire 9 is made contact with the outer periphery of the conductor 11 by extrusion molding or the like to maintain a state in which the insulation coating 13 is still formed. Therefore, a relatively large adhesive force is generated between the conductor 11 and the insulation coating 13. However, since the force F1l is applied to the conductor 11 from the outside of the insulation coating 13 with respect to the base-material flat electric wire 9 in the low-flatness portion 30 to deform the conductor 11, the adhesion between the insulation coating 13 and the conductor 11 is eliminated or reduced in conjunction with the application of the force F1 and the deformation of the conductor 11. Therefore, in the low-flatness portion 30, the adhesive force between the insulation coating 13 and the conductor 11 is likely to be significantly smaller than in the flat portion 20.

Since the adhesive force between the conductor 11 and the insulation coating 13 is made small in the low-flatness portion 30, the ease of processing the low-flatness portion 30 associated with the removal of the insulation coating 13 is further improved in addition to the effect of the shape itself that the degree of flatness described above is low. This is because the insulation coating 13 exerts only a low adhesive force to the conductor 11, so that only a small force is required to peel and remove the insulation coating 13 from the outer periphery of the conductor 11 in the low-flatness portion 30. From the viewpoint of enhancing the effect of improving the peelability of the insulation coating 13, the adhesive force in the low-flatness portion 30 is preferably small, for example, it is preferably smaller by at least 5%, further at least 10%, at least 20%, or at least 30% than the adhesive force in the flat portion 20. That is, assuming that the adhesive force of the flat portion 20 is A1, and the adhesive force of the low-flatness portion 30 is A2, an adhesive force differential rate ΔA expressed by the following formula (1) is preferably ΔA≤−5%, further ΔA≤−10%, or ΔA≤−20%, or ΔA≤−30%.

$$Δ A = ( A 2 - A 1 ) / A 1 \qquad ( 1 )$$

From the viewpoint of improving the peelability of the insulation coating 13, there is no particular lower limit for the adhesive force of the low-flatness portion 30, but from the viewpoint of prevention of positional displacement of the insulation coating 13 with respect to the conductor 11, etc., it is preferable to keep the adhesive force differential rate within a range of ΔA≥−90% and ΔA≥−80% or less, for example.

The low-flatness portion 30 enhances the peelability of the insulation coating 13 due to the low adhesion between the conductor 11 and the insulation coating 13, while in the flat portion 20, the insulation coating 13 is adhered to the outer periphery of the conductor 11 with a large adhesive force, so that the positional displacement of the insulation coating 13 with respect to the conductor 11 is suppressed. Further, when the conductor 11 is energized so that the conductor 11 generates heat, the heat is efficiently transmitted to the insulation coating 13 without passing through an air layer at the portion where the insulation coating 13 and the conductor 11 are in close contact with each other. In addition, since the heat is dissipated in the external environment, high heat dissipation is ensured in the flat portion 20. These effects of suppressing the positional displacement and improving the heat dissipation in the flat portion 20 are exhibited as the characteristics of the entire insulated electric wire 1.

The adhesive force between the conductor 11 and the insulation coating 13 can be evaluated by a pull-out test. As a specific test method, for example, a portion containing only the flat portion 20 or a portion containing only the low-flatness portion 30 is cut out from the insulated electric wire 1, and the insulation coating 13 is peeled off over a region of a predetermined length at its end to expose the conductor 11. Then, in a state in which the exposed conductor 11 is inserted into a through hole having the same shape as the outer shape of the conductor 11, the conductor 11 is pulled at a predetermined speed to pull out the conductor 11 from the insulation coating 13. The load required for pulling out is measured with a load cell or the like, and the maximum load may be taken as the adhesive force of the insulation coating 13 to the conductor 11. Then, the measured adhesive forces may be compared with each other between the flat portion 20 and the low-flatness portion 30 cut to the same length.

### (2) Distribution of Vacancies

In the cross-section of the insulated electric wire 1 according to the present embodiment, there is also a difference in the distribution of vacancies between the flat portion 20 and the low-flatness portion 30 in the region surrounded by the insulation coating 13. In the insulated electric wire 1 according to the present embodiment, the low-flatness portion 30 is easy to become higher in ratio of vacancies than the flat portion 20. Here, the ratio of vacancies refers to the ratio of the area of vacancies not occupied by the elemental wires 12 to the area of the region surrounded by the inner periphery of the insulation coating 13 in the cross-section of the insulated electric wire 1.

The ratio of vacancies is easy to become large in the low-flatness portion 30 because this relates to the method of forming the low-flatness portion 30. When the low-flatness portion 30 is formed by applying a force F1 from outside of the base-material flat electric wire 9, the conductor 11 is deformed in the cross-section of the insulated electric wire 1, and the shape of the insulation coating 13 also changes in the direction of lowering the degree of flatness, but the inner circumferential length of the insulation coating 13 does not substantially change. If the inner circumferential length of the insulation coating 13 is the same, the area of the region surrounded by the inner periphery of the insulation coating 13 increases as the insulation coating 13 deforms into a shape with a low degree of flatness. At this time, since the area occupied by the elemental wires 12 does not change in the region surrounded by the inner periphery of the insulation coating 13, the area of the vacancies not occupied by the elemental wires 12 increases, and hence the ratio of vacancies increases.

Since the force F1 is applied to the conductor 11 from the outside of the insulation coating 13 when forming the low-flatness portion 30, the vacancy is likely to be formed between the outer periphery of the conductor 11 and the inner periphery of the insulation coating 13. The formation of the vacancy between the conductor 11 and the insulation coating 13 also contributes to the reduction of the adhesive force between the conductor 11 and the insulation coating 13. In particular, the force F1 for deforming the conductor 11 is applied from the outer side to the inner side in the width direction to compress the dimension of the conductor 11 in the width direction. Therefore, as shown in FIG. 2B, the vacancies are likely to be unevenly distributed in the outer region in the width equivalent direction of the conductor 11. That is, a vacancy larger than in a height-directional conductor-outside region Rh corresponding to the outer region of the conductor 11 along the height equivalent direction (z direction) is likely to be formed in a width-directional conductor-outside region Rw corresponding to the outer region of the conductor 11 along the width equivalent direction (y direction). As a result, the distance between the conductor 11 and the inner peripheral surface of the insulation coating 13 is likely to become larger in the width-directional conductor-outside region Rw than in the height-directional conductor-outside region Rh. Further, the adhesive force between the conductor 11 and the insulation coating 13 is likely to be smaller in the width equivalent direction than in the height equivalent direction. Not only in the low-flatness portion 30, but also in the boundary portion between the low-flatness portion 30 and the flat portion 20, uneven distribution of vacancies to the width-directional conductor-outside region Rw may occur.

Increasing the ratio of vacancies in the low-flatness portion 30 has the effect of not only reducing the adhesive force between the conductor 11 and the insulation coating 13 but also enhancing bending flexibility of the insulated electric wire 1 in the low-flatness portion 30. This is because when the conductor 11 is bent, the flexible bending of the insulated electric wire 1 is assisted by the movement of the elemental wires 12 into the vacancy. Vacancies formed between the conductor 11 and the insulation coating 13, such as the width-directional conductor-outside region Rw, etc. also have an effect of improving flexibility, but inside the conductor 11, vacancies formed between the elemental wires 12 are particularly highly effective in improving flexibility. Therefore, as for not only the vacancy in the entire region surrounded by the inner periphery of the insulation coating 13 but also the vacancies in the region inside the conductor 11 from the viewpoint of improving the bending flexibility of the low-flatness portion 30, it is preferable that the low-flatness portion 30 has a higher ratio of vacancies than the flat portion 20.

A specific ratio of vacancies in the low-flatness portion 30 is not limited in particular. However, it is preferable that the ratio of vacancies of the low-flatness portion 30 is 5% or higher, further 10% or higher, 20% or higher, 30% or higher, or 45% or higher than the flat portion 20. That is, when the ratio of vacancies in the flat portion 20 is taken as V1 (%) and the ratio of vacancies in the low-flatness portion 30 is taken as V2 (%), a ratio of vacancies differential rate ΔV expressed by the following formula (2) is preferably ΔV≥+5%, further ΔV≥+10%, ΔV≥+20%, ΔV≥+30%, or ΔV≥+45%.

$$Δ V = ( V 2 - V 1 ) / V 1 \qquad ( 2 )$$

Further, the value of the ratio of vacancies (V2) in the low-flatness portion 30 is preferably 30% or more, further 35% or more, or 40% or more. Then, in the low-flatness portion 30, it becomes easier to reduce the adhesive force between the insulation coating 13 and the conductor 11, and it becomes easier to secure high flexibility. Also in the flat portion 20, the ratio of vacancies (V1) of the flat portion 20 is preferably 10% or more, more preferably 20% or more from the viewpoint of ensuring bending flexibility in the height equivalent direction (z direction). From the viewpoint of flexibility, there is no particular upper limit to the ratio of vacancies (V1, V2), but in each of the flat portion 20 and the low-flatness portion 30, the ratio of vacancies is preferably set to approximately 50% or less from the viewpoint of stably holding the outer shape of a predetermined conductor 11, etc.

As described above, when the low-flatness portion 30 is formed by applying the force F1 to the base-material flat electric wire 9 to deform the conductor 11, the length of the inner circumference (inner circumferential length) of the insulation coating 13 remains almost unchanged, and the ratio of vacancies of the low-flatness portion 30 increases due to an increase in the area associated with low flattening of the region surrounded by the inner periphery of the insulation coating 13. From the viewpoint of enhancing the effect of increasing the ratio of vacancies in the low-flatness portion 30 by this mechanism, the amount of change in the inner circumferential length of the insulation coating 13 accompanying the formation of the low-flatness portion 30, i.e., the difference in the inner circumferential length of the insulation coating 13 between the flat portion 20 and the low-flatness portion 30 is preferably small. For example, the difference in the inner circumferential length of the insulation coating 13 between the flat portion 20 and the low-flatness portion 30 is preferably 5% or less with respect to the inner circumferential length of the insulation coating 13 in the flat portion 20. That is, assuming that the inner circumferential length of the insulation coating 13 in the flat portion 20 is D1 and the inner circumferential length of the insulation coating 13 in the low-flatness portion 30 is D2, a circumferential length differential rate ΔD expressed by the following formula (3) is preferably |ΔD|≤5%. Further, it is preferable that |ΔD|≤2%.

$$Δ D = ( D 2 - D 1 ) / D 1 \qquad ( 3 )$$

Further, from the viewpoint of enhancing the effect of increasing the ratio of vacancies in the low-flatness portion 30 by the above mechanism, it is preferable to greatly increase the area (inner area) of the region surrounded by the inner periphery of the insulation coating 13 along with the formation of the low-flatness portion 30. That is, it is preferable that the inner area of the low-flatness portion 30 is larger than the flat portion 20. For example, the inner area of the low-flatness portion 30 may be 30% or more, or even 50% or larger than the flat portion 20. That is, assuming that the inner area of the flat portion 20 is S1 and the inner area of the low-flatness portion 30 is S2, an inner area differential rate ΔS expressed by the following formula (4) is preferably ΔS≥+10%, or further ΔS≥+20% or more.

$$Δ S = ( S 2 - S 1 ) / S 1 \qquad ( 4 )$$

### (3) Deformation of Elemental Wires

When manufacturing the insulated electric wire 1 according to the present embodiment with the formation of the low-flatness portion 30 by applying the force F1 to the base-material flat electric wire 9 from the width direction, the deformation ratio of the elemental wires 12 in the cross-section are likely to be unevenly distributed in the flat portion 20 and the low-flatness portion 30, corresponding to the manufacturing method. Here, the deformation ratio of the elemental wires 12 is an index indicating how much a certain elemental wire 12 has a cross-sectional shape that deviates from a circular shape. The greater the deviation of the shape of the elemental wire 12 from the circular shape, the greater the rate of deformation.

Specifically, in both the flat portion 20 and the low-flatness portion 30 as shown in FIGS. 2A and 2B, the deformation ratios of the elemental wires 12 at width-directional end parts (e.g., region R2) corresponding to regions facing an outer periphery of the conductor 11 at outer sides (both end parts) along the width equivalent direction (y direction), tend to be lower than the deformation ratios of the elemental wires 12 at center part (region R1) located at an inner side of the outer periphery of the conductor 11 or at height-directional end parts (e.g., region R3) located at outer sides (both end parts) along the height equivalent direction (z direction). In other words, in the flat portion 20 and the low-flatness portion 30, the elemental wires 12 at the width-directional end parts are more likely to have a shape closer to a circular shape than the elemental wires 12 at the center part and the height-directional end parts.

As described above, when the insulated electric wire 1 according to the present embodiment is formed from the base-material flat electric wire 9 containing a twisted conductor formed into a flat shape, the conductor 11 included in the base-material flat electric wire 9 is flattened by application of the gentle force to the twisted wire using the roller. Due to this, as described even in Patent Literatures 3 to 5, the outer peripheral portion, particularly an width-directional end part has an elemental wire deformation ratio lower than in the center part. When the insulated electric wire 1 according to the present embodiment is manufactured from the base-material flat electric wire 9, the structure of the conductor 11 in the base-material flat electric wire 9 is inherited substantially as it is in the flat portion 20. Even in the low-flatness portion 30, the outer shape of the entire conductor 11 is deformed into a shape with a low degree of flatness, but the deformation does not easily extend to each elemental wire 12, and the shape of each elemental wire 12 is almost unchanged. Therefore, the distribution of the deformation ratio of the elemental wires 12 having occurred in the base-material flat electric wire 9 is carried over even to the low-flatness portion 30 almost as it is. Thus, even in the flat portion 20 and the low-flatness portion 30 of the insulated electric wire 1 according to the present embodiment, as with the base-material flat electric wire 9, the deformation ratio of the elemental wires 12 becomes lower at the wide directional end than in the center part and the height-directional end parts.

<Deformed Form: Form in which Flattening Direction of Flat Portion is Changed>

In the above, the description has focused on the form in which the low-flatness portions 30 are formed at both ends of one insulated electric wire 1, and the flat portion 20 having the uniform shape is formed at the position sandwiched between the low-flatness portions 30. However, the number and arrangement of the flat portion 20 and the low-flatness portions 30 are not limited thereto, and any number of them can be provided in any arrangement order. For example, as the flat portion 20, a plurality of regions different in the flat direction can be provided. Those plural regions may be provided adjacent to each other or may be provided with the low-flatness portion 30 interposed therebetween.

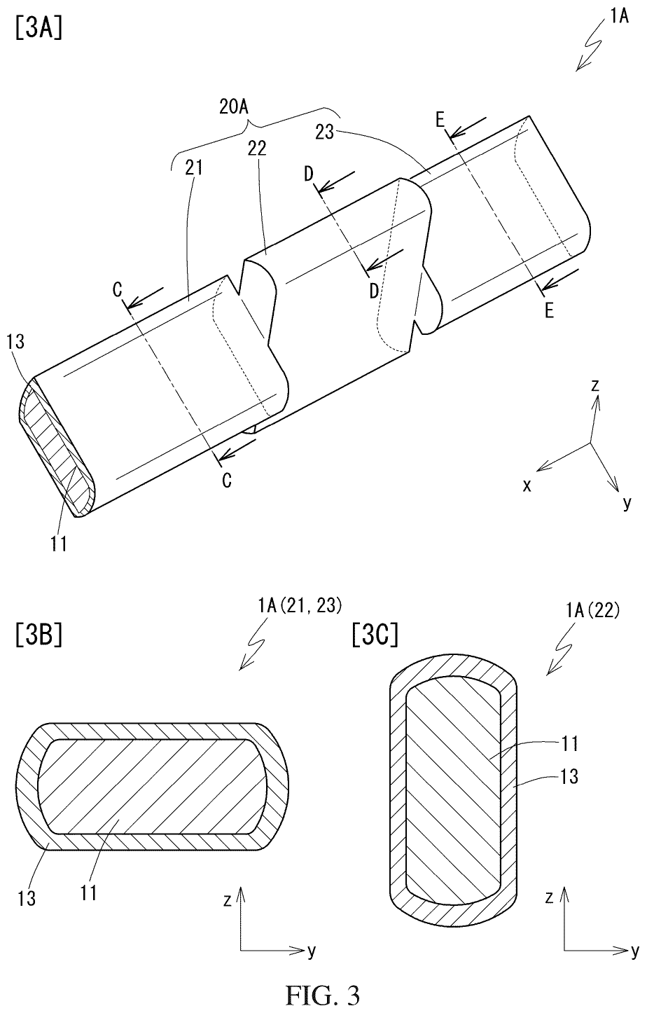

As an example of providing a plurality of regions in the flat portion, there is shown in FIGS. 3A to 3C, an insulated electric wire 1A in which a flat portion 20A is provided with a first region 21, a second region 22, and a third region 3 as a plurality of regions different in the flat direction. These three regions 21 to 23 are continuously provided in this order along the axial direction of the insulated electric wire 1A. Further, although illustration is omitted, along the axial direction of the insulated electric wire 1A, low-flatness portions are provided at both ends of the insulated electric wire 1A corresponding to regions (on the opposite sides to the second region 22) outside the first region 21 and the third region 23. In the flat portion 20A, the first region 21, the second region 22, and the third region 23 are different from each other in the flat direction. Here, the flat direction indicates the direction of the flat outer shape of the cross-section, that is, the direction in which the width direction, which is the direction in which the flat outer shape extends flatly, is oriented.

Specifically, the first region 21 and the third region 23 have a horizontally long flat outer shape whose flat direction is oriented in the y direction. On the other hand, the second region 22 has a vertically long flat outer shape whose flat direction is oriented in the z direction. The respective regions 21 to 23 are directly adjacent to each other, except for regions that inevitably occur with abrupt changes in the flat direction.

The flat portion of the insulated electric wire does not exhibit very high flexibility in the width direction of the flat outer shape (i.e., the flat direction) and the insulated electric wire is hard to bend, but in the height direction, the flat portion exhibits high flexibility and the insulated electric wire is easy to bend. Thus, when the flat portion has anisotropic flexibility and there are a plurality of regions different in the flat direction as the flat portion, the direction in which the insulated electric wire is easy to bend is different in those plural regions. In the example shown in FIGS. 3A to 3C, the horizontally long first region 21 and third region 23 are easy to bend in the vertical direction (z direction), whereas the vertically long second region 22 is easy to bend in the horizontal direction (y direction).

Thus, the provision of the plural regions 21 to 23 different in the flat direction as the flat portion 20A makes it easy to bend each part of the flat portion 20A of the insulated electric wire 1A in the different directions. By bending the insulated electric wire 1A in the different directions in those regions 21 to 23, the insulated electric wire 1A can be suitably utilized for applications that require bending into complicated shapes, such as three-dimensional routing and routing along articles with complicated shapes, etc. In the insulated electric wire 1A, depending on the specific wiring routes or the like, a region with the height direction of the flat outer shape facing the direction to be bent may be formed by a required number at a position where bending is to be formed.

In each of the regions 21 to 23 of the flat portion 20A, the specific flat direction may be appropriately determined according to the direction in which the insulated electric wire 1A is to be bent, as described above, and the difference in the flat direction between adjacent regions is also not limited in particular. For example, if the difference in the flat direction between the adjacent regions is set to 10° or more, it is possible to sufficiently obtain the effect of realizing bending in various directions by providing a plurality of regions different in the flat direction. However, the greater the difference in the flat direction between the adjacent regions, the easier it is to bend into a complicated shape. For example, in the embodiment shown in FIGS. 3A to 3C, the difference in the flat direction between the first region 21 and the second region 22 and the difference in the flat direction between the second region 22 and the third region 23 are both 90°. Thus, in the flat portion 20A, the difference in the flat direction between the adjacent regions is preferably set to 45° or more, particularly 80° or more.

If each of the plurality of regions 21 to 23 has the degree of flatness higher than the low-flatness portion when the regions 21 to 23 different in the flat direction are provided in the flat portion 20A, the specific degree of flatness of each of the regions 21 to 23 (the aspect ratio of the flat outer shape of the cross-section), and the relationship of the degree of flatness between the regions 21 to 23 are not limited in particular. However, in order to allow each of the regions 21 to 23 to exhibit the same degree of flexibility in the height direction of each flat outer shape and to make the insulated electric wire 1A bend equally flexibly in each direction, it is preferable that the regions 21 to 23 different in the flat direction exhibit the same degree of flatness. For example, in the flat portion 20A, it is preferable that the aspect ratio of the cross-sectional shape of one region is taken as a reference, and the aspect ratio of the cross-sectional shape of the adjacent region is 80% or more and 120% or less. In the illustrated form, the degrees of flatness of the three regions 21 to 23 are the same.

Thus, as the flat portion 20A, the insulated electric wire 1A having the plural regions 21 to 23 different in the flat direction can also be suitably manufactured like the insulated electric wire 1 described in detail above by selectively applying a force to a required region with respect to the base-material flat electric wire 9 obtained by deforming the conductor 11 into a flat outer shape to partially deform the base-material flat electric wire 9. At this time, one of the plurality of flat regions different in the flat direction or a plurality of regions thereof having the same flat direction may be left and formed without deforming the base-material flat electric wire 9 from the original flat outer shape. On the other hand, a region different in the flat direction from the original base-material flat electric wire 9 in the low-flatness portion and the flat portion 20A may be formed at a required portion by applying the force to the base-material flat electric wire 9 from outside to inside along the width direction (y direction). At this time, a force larger than at the portion where the low-flatness portion is formed, is applied to a portion where a flat region different in the flat direction from the original base-material flat electric wire 9 is formed, thereby greatly deforming the base-material flat electric wire 9 to a state in which the flat direction changes from the original state. When manufacturing the insulated electric wire 1A shown in FIGS. 3A to 3C, for example, the flat direction of the base-material flat electric wire 9 is oriented in the y direction, and in the middle of the base-material flat electric wire 9 in its axial direction, a force is applied from outside to inside along the width direction (y direction) to deform the cross-sectional shape from a horizontally long state to a vertically long state, so that the second region 22 can be formed. On the other hand, the first region 21 and the third region 23 can be formed at the portions on both sides of the second region 22 in the axial direction by leaving the horizontally long flat outer shape of the base-material flat electric wire 9 as it is without changing its flat outer shape.

### Another Embodiment

In the insulated electric wire 1 according to the embodiment described above, the base-material flat electric wire 9 including the flat conductor 11 is processed to form the low-flatness portion 30 in the partial region and leave the region other than that as the flat portion 20, thereby causing the flat portion 20 and the low-flatness portion 30 to coexist with each other. However, the insulated electric wire in which the flat portion and the low-flatness portion coexist can be manufactured even by another method. An insulated electric wire 1′ formed by another method will be briefly described below. In the following, the description of the same configurations as those of the above-described embodiment are omitted, and the description will focus on points that are different from the above.

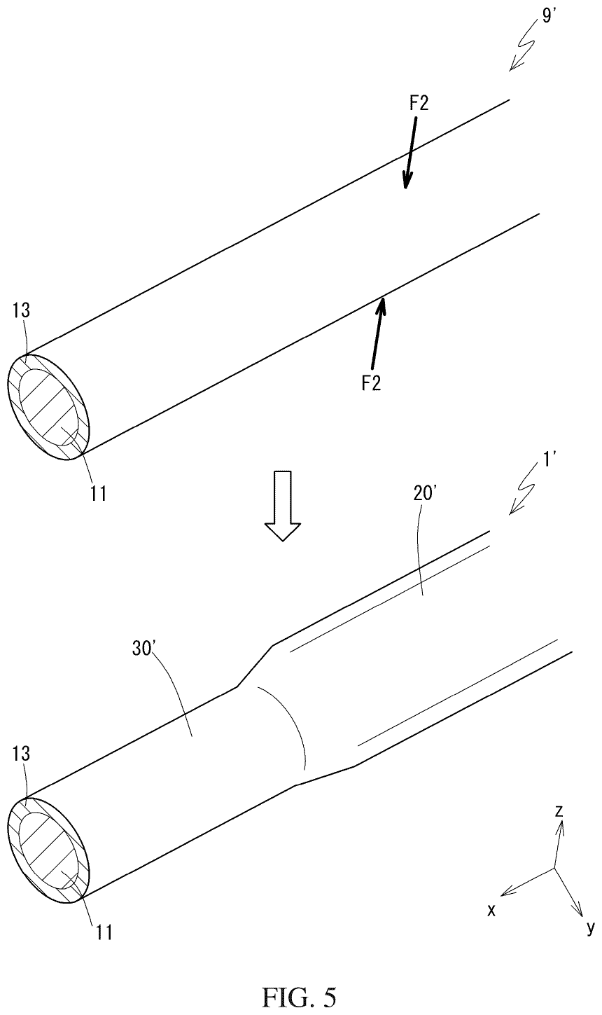

The insulated electric wire 1′ according to another embodiment can be manufactured using a base-material low-flatness electric wire 9′ as shown in FIG. 5. Here, the base-material low-flatness electric wire 9′ includes the insulated electric wire 1′ formed by covering, with an insulation coating 13, the outer periphery of a conductor 11 in which a plurality of elemental wires 12 are twisted together. The cross-section of the conductor 11 has an outer shape low in the degree of flatness, such as an approximately circular shape. For example, a general-purpose round electric wire can be utilized as it is as the base-material low-flatness electric wire 9′.

Compressive forces F2 are applied to the base-material low-flatness electric wire 9′ from the directions facing each other in a partial region to increase the degree of flatness of the conductor 11, thereby forming a flat portion 20′. Then, a region other than the region as the flat portion 20′ is left as a low-flatness portion 30′. Thus, it is possible to manufacture the insulated electric wire 1′ having the flat portion 20′ and the low-flatness portion 30′. That is, in the insulated electric wire 1 according to the embodiment described above, the low-flatness portion 30 is formed by processing the base-material flat electric wire 9, and the remaining portion is formed as the flat portion 20. On the other hand, in the insulated electric wire 1′ according to another embodiment, the flat portion 20′ is formed by processing the base-material low-flatness electric wire 9′, and the remaining portion is formed as the low-flatness portion 30′.

Even in the insulated electric wire 1′ according to another embodiment, as with the insulated electric wire 1 described above, in the flat portion 20′, the insulation coating 13 is in contact with the conductor 11 in an area wider than in the low-flatness portion 30′. Therefore, the adhesive force between the conductor 11 and the insulation coating 13 becomes smaller in the low-flatness portion 30′ than in the flat portion 20′. Thus, by providing the low-flatness portion 30′ at the terminal portion of the insulated electric wire 1′ or the like, the processing of the insulated electric wire 1′ accompanying the removal of the insulation coating 13 can be simply performed in the low-flatness portion 30′ by the effect of the small adhesive force between the conductor 11 and the insulation coating 13 in combination with the effect of the low degree of flatness of the outer shape itself. Also in this embodiment, for example, the adhesive force in the low-flatness portion 30′ can be reduced by 20% or more, further 30% or more in comparison with the adhesive force in the flat portion 20′ (ΔA≤−20% or even ΔA≤−30%)).

However, in the insulated electric wire 1′ according to another embodiment, as shown even in later embodiments, it is hard to form a state with a ratio of vacancies higher in the low-flatness portion 30′ than in the flat portion 20′ unlike the insulated electric wire 1 described above. Further, when the base-material low-flatness electric wire 9′ is compressed into a flat outer shape, the inner circumferential length of the insulation coating 13 may be stretched as the degree of flatness increases. With the inner circumferential length of the insulation coating 13 being stretched, the adhesion between the conductor 11 and the insulation coating 13 becomes strong at the outer portion in the width direction, and the adhesive force becomes larger in the flat portion 20′ than in the low-flatness portion 30′. In such a way that an undue load is not applied to the insulation coating 13 when the inner circumferential length of the insulation coating 13 is stretched, a material that is relatively low in tensile elastic modulus and is likely to be stretched is preferably used as the insulation coating 13. Further, in the insulated electric wire 1′ of this form, the force to deform the conductor 11 is not applied to the low-flatness portion 30′ even during both manufacturing of the base-material low-flatness electric wire 9′ and processing from the base-material low-flatness electric wire 9′. Thus, in the cross-section of the low-flatness portion 30′, the elemental wire 12 maintains a shape close to a circular cross-section which is low in deformation ratio, regardless of the position.

The insulated electric wire 1A including the plural regions 21 to 23 different in the flat direction can be manufactured as the flat portion 20A as shown in FIGS. 3A to 3C even by a method similar to that in the insulated electric wire 1′ described here. In this case, a plurality of regions different in the direction to apply the force are set when forming the flat portion 20A by applying the force to the base-material low-flatness electric wire 9′, so that it is possible to form the multiple regions 21 to 23 different in the flat direction. When manufacturing the insulated electric wire 1A having the shape shown in FIGS. 3A to 3C, a force to compress the base-material low-flatness electric wire 9′ along the z direction is applied to the positions where the horizontally long first region 21 and third region 23 are to be formed. A force to compress the base-material low-flatness electric wire 9′ along the y direction is applied to the position where the vertically long second region 22 is to be formed.

### Examples

Examples are shown below. Note that the present invention is not limited by these examples. Here, as for two types of insulated electric wires, the states thereof were compared between the flat portion and the low-flatness portion.

### (Sample Preparation)

### (1) Sample 1

At first, a base-material flat electric wire was produced. First, a twisted wire having a substantially circular cross-section made by twisting aluminum alloy elemental wires was prepared, and a conductor was produced by compressing the twisted wire into a flat outer shape with a roller. A twisted wire having a conductor cross-sectional area of 130 mm² and an elemental wire diameter of 0.42 mm was used. The aspect ratio w/h of the flat outer shape was set to about 3. An insulation coating was formed on the outer periphery of the produced conductor by extrusion molding to obtain a base-material flat electric wire. Cross-linked polyethylene was used as a constituent material of the insulation coating, and the thickness of the insulation coating was set to 2 mm.

A low-flatness portion was formed by applying a force directed from the outside in the width direction of the flat outer shape to the inside in a partial region to the base-material flat electric wire to reduce the degree of flatness of the flat outer shape of the conductor. A region where no force was applied was left as a flat portion. The aspect ratio w/h of the conductor in the low-flatness portion was set to about 1. The formation of the low-flatness portion was conducted by press working at room temperature.

### (2) Sample 2

At first, a base-material low-flatness electric wire was prepared. First, a twisted wire having a substantially circular cross-section made by twisting aluminum alloy elemental wires was prepared. A twisted wire having a conductor cross-sectional area of 60 mm² and an elemental wire diameter of 0.32 mm was used. An insulation coating was formed on the outer periphery of the produced conductor by extrusion molding to obtain a base-material flat electric wire. Polyvinyl chloride was used as a constituent material of the insulation coating, and the thickness of the insulation coating was set to 2 mm.

A flat portion was formed by applying a clamping force from opposite directions to the above base-material low-flatness electric wire in a partial region to compress the conductor, thereby increasing the degree of flatness thereof. A region where no force was applied was left as a low-flatness portion. The aspect ratio w/h of the conductor in the flat portion was set to about 3. The formation of the flat portion was conducted by press working at room temperature.

### (Evaluation Method)

Cross-sectional observation was done for each of the flat portion and the low-flatness portion of Samples 1 and 2 produced above. Specifically, each sample was embedded in and fixed to an acrylic resin. Then, cross-sectional samples were obtained by cutting the insulated electric wire vertically to the axial direction at the respective portions of the flat portion and the low-flatness portion. The obtained cross-sectional sample was observed with a microscope, and image analysis was conducted on the observed image to evaluate the vacancy area, inner area, ratio of vacancies, and inner circumferential length of the region inside the insulation coating. For the low-flatness portion of Sample 1 and the flat portion of Sample 2, cross-sectional samples were produced at three positions 1 to 3 and evaluated, and the obtained values were averaged at the three positions.

Separately, for the insulated electric wires of Samples 1 and 2, the adhesive force between the conductor and the insulation coating was evaluated in each of the flat portion and the low-flatness portion. A region containing only the flat portion or only the low-flatness portion of each sample was cut to 70 mm, and the insulation coating in a region of 25 mm from the end was peeled off to expose the conductor. A through hole having the same shape as the outer shape of the conductor was formed in a metal plate, and the exposed conductor was inserted into the through hole. Then, the conductor was pulled at a speed of 250 mm/sec to pull out the conductor out of the insulation coating. A load required for its pulling was measured with a load cell, and the maximum load was defined as the adhesive force of the insulation coating to the conductor.

### (Evaluation Results)

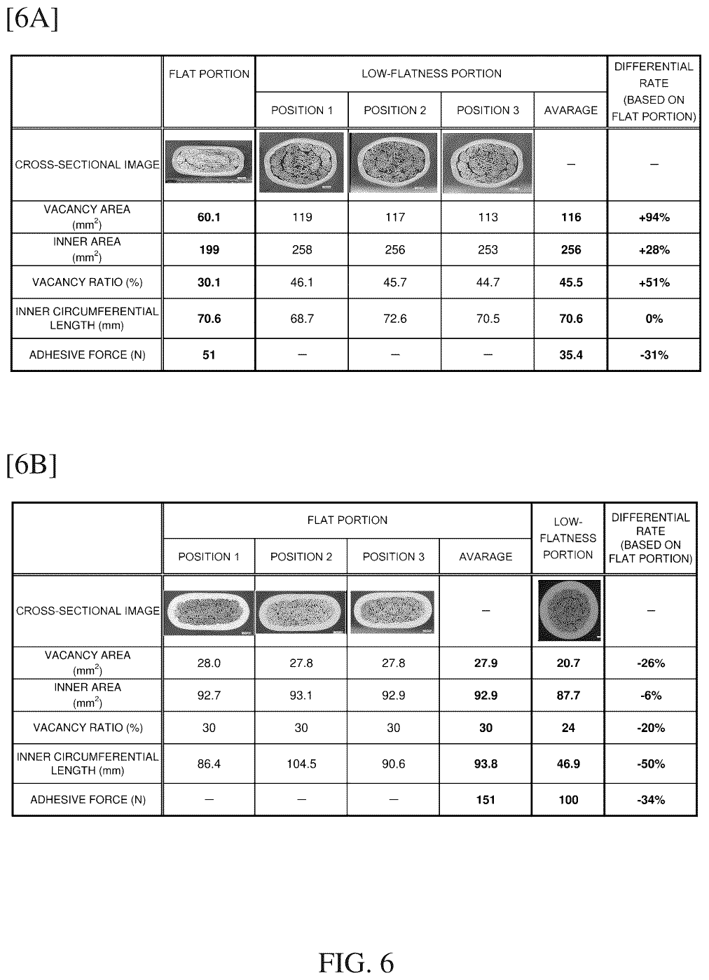

FIGS. 6A and 6B show the cross-sectional images at each position, the evaluation results of the state of the cross-sections, and the measured results of the adhesive force for the Samples 1 and 2, respectively. In the cross-sectional images, the scales for the flat portion and the low-flatness portion are changed as appropriate. The rate of the difference between the flat portion and the low-flatness portion is shown in Table together for each measured value. Here, the differential rate indicates how much the value of the low-flatness portion changes based on the value of the flat portion. That is, the differential rate is expressed by the following formula (5):

$$Differential rate = ( Value of Low ‐ flatness portion - Value of Flat portion ) / Value of Flat portion \times 100 \% \qquad ( 5 )$$

When the cross-sections are evaluated at the multiple positions, the average value is used to calculate the differential rate. In FIGS. 6A and 6B, the values used to calculate the differential rate and the calculated differential rate are indicated in bold.

According to the cross-sectional image of Sample 1 shown in FIG. 6A, it is confirmed that the low-flatness portion formed by applying the force to the base-material flat electric wire has a shape lower in degree of flatness than in the flat portion. Then, when the measurement results of the adhesive force are compared between the flat portion and the low-flatness portion, the low-flatness portion has a smaller value, and looking at the differential rate, it assumes ΔA≤−30%. In other words, the adhesive force between the insulation coating and the conductor is reduced by 30% or more due to the low flattening.

Focusing attention on the distribution of vacancies which are regions not occupied by elemental wires in the cross-sectional image, first the insulation coating is closely adhered to the outer periphery of the conductor in the flat portion, and the vacancies between the conductor and the insulation coating are very small. On the other hand, in the low-flatness portion, clear vacancies are generated between the conductor and the insulation coating. Further, the vacancies are unevenly distributed in the width equivalent direction (horizontal direction of the image). The uneven distribution of the vacancies is particularly noticeable at the positions 2 and 3. In addition, it can be seen that the vacancy in the region between the elemental wires inside the conductor is also larger in the low-flatness portion than in the flat portion. From these points, it can be seen that the vacancies formed in the region surrounded by the inner circumference of the insulation coating are larger in the low-flatness portion than in the flat portion. These results are more clearly shown by the fact that the measured values of the vacancy area and the ratio of vacancies are higher in the low-flatness portion than in the flat portion, and the differential value between them takes a positive value. Regarding the ratio of vacancies, it becomes higher in the low-flatness portion by 50% or higher with the value of the flat portion as the reference (ΔV≥+50%).

The inner circumferential length of the insulation coating remains unchanged between the flat portion and the low-flatness portion (ΔD=0%). On the other hand, the inner area of the insulation coating is 20% or larger in the low-flatness portion than the value of the flat portion (ΔS≥+20%).

It is interpreted from the above results that when the force is applied to the base-material flat electric wire from the outside in the width direction to form the low-flatness portion, the conductor is deformed into the low flat outer shape inside the space where the change in the inner circumferential length of the insulation coating is restricted, so that the area of the space surrounded by the inner peripheral surface of the insulation coating is increased, thereby increasing the ratio of vacancies. Further, it is conceivable that the adhesive force between the insulation coating and the conductor is reduced due to the increase in the ratio of vacancies, particularly the formation of vacancies in the region between the conductor and the insulation coating.

Next, according to the cross-sectional image of Sample 2 shown in FIG. 6B, it is confirmed that the low-flatness portion where the structure of the base-material low-flatness electric wire is left, has a shape lower in degree of flatness than in the flat portion formed by applying the compressive force to the base-material low-flatness electric wire. Comparing the measurement results of the adhesive force between the flat portion and the low-flatness portion, the low-flatness portion has a smaller value, and looking at the differential rate, it assumes ΔA≤−30%. In other words, the adhesive force between the insulation coating and the conductor increases by the compression of the base-material low-flatness electric wire, and the low-flatness portion remains in a state in which the adhesive force is lower by at least 30% than the flat portion formed through compression.

Focusing attention on the distribution of vacancies in the cross-sectional image, almost no vacancies is formed between the conductor and the insulation coating in both the flat portion and the low-flatness portion. It can be seen that the vacancy between the elemental wires inside the conductor is larger in the flat portion than in the low-flatness portion. That is, it can be understood that the vacancy formed in the region surrounded by the inner circumference of the insulation coating is larger in the flat portion than in the low-flatness portion. These results are more clearly shown by the fact that the measured values of the vacancy area and ratio of vacancies are higher in the flat portion than in the low-flatness portion, and the differential rate also assumes a negative value. This result means that the vacancies inside the conductor increase due to the compression from the low-flatness outer shape to the flat outer shape.

In Sample 1, the inner circumferential length of the insulation coating does not change through the formation of the low-flatness portion by the application of the force. On the other hand, in Sample 2, the inner circumferential length of the insulation coating is longer in the flat portion than in the low-flatness portion (differential rate ΔD≤0), and the inner circumferential length of the insulation coating is extended through the formation of the flat portion by the application of the force. This phenomenon is considered to be due to the extension of the insulation coating along with the deformation of the conductor when compressing the conductor by the application of the force.

Although the embodiments of the present disclosure have been described in detail above, the present invention is by no means limited to the above embodiments, and various modifications are possible within the scope not departing from the gist of the present invention.

### REFERENCE SIGNS LIST

1, 1′, 1A: insulated electric wire
11: conductor
12: elemental wire
13: insulation coating
20, 20′, 20A: flat portion
21: first region
22: second region
23: third region
30, 30′: low-flatness portion
9: base-material flat electric wire
9′: base-material low-flatness electric wire
h: height of conductor
w: width of conductor
x: axial direction of insulated electric wire
y: width equivalent direction
z: height equivalent direction
F1: force
F2: force
R1: region of center part
R2: region of width-directional end parts
R3: region of height-directional end parts
Rh: height-directional conductor-outside region
Rw: width-directional conductor-outside region

1. An insulated electric wire, comprising:
a conductor comprising a plurality of elemental wires twisted together; and
an insulation coating covering an outer periphery of the conductor, wherein
the insulated electric wire comprises a flat portion and a low-flatness portion along an axial direction of the insulated electric wire, where the plurality of elemental wires constituting the conductor and the insulation coating are each continuous through these portions;
the conductor has, in a cross section perpendicular to the axial direction, a flat outer shape in the flat portion and a less flat outer shape in the low-flatness portion than in the flat portion in the insulated electric wire;
the insulated electric wire has an adhesive force between the conductor and the insulation coating which is smaller in the low-flatness portion than in the flat portion; and
the low-flatness portion has a vacancy ratio higher than the flat portion, the vacancy ratio defined as a ratio of vacancies not occupied by the elemental wires in an area surrounded by an inner periphery of the insulation coating in the cross section of the insulated electric wire.

2. The insulated electric wire according to claim 1, wherein the adhesive force between the conductor and the insulation coating is smaller by at least 20% in the low-flatness portion than in the flat portion.

3. The insulated electric wire according to claim 1, wherein the vacancy ratio in the cross section is higher by at least 20% in the low-flatness portion than in the flat portion.

4. The insulated electric wire according to claim 1, wherein
defining a region outside the conductor in the cross section of the low-flatness portion along directions corresponding to the width direction and the height direction of the flat outer shape as a width-directional conductor-outside region and a height-directional conductor-outside region, respectively, and
the insulated electric wire has a larger vacancy between the conductor and the insulation coating in the width-directional conductor-outside region than in the height-directional conductor-outside region.

5. The insulated electric wire according to claim 1, wherein difference in length of the inner periphery of the insulation coating between the flat portion and the low-flatness portion is within 5% of the length of the inner periphery of the insulation coating in the flat portion.

6. The insulated electric wire according to claim 1, wherein difference in length of the inner periphery of the insulation coating between the flat portion and the low-flatness portions is within 5% of the length of the inner periphery of the insulation coating in the flat portion, and
in the cross section, defining the width and height of the conductor as w and h, respectively, an aspect ratio w/h of the conductor in the low-flatness portion is 70% or lower than the aspect ratio in the flat portion.

7. The insulated electric wire according to claim 1, wherein the flat portion comprises a plurality of regions whose flat shapes are oriented in mutually different directions.

8. The insulated electric wire according to claim 1, wherein the insulated electric wire has the low-flatness portion on at least one side of the flat portion along the axial direction of the insulated electric wire.

9. An insulated electric wire manufactured by steps of:
making an insulated electric wire by compressing a conductor in which a plurality of elemental wires are twisted together into a flat outer shape and by covering an outer periphery of the conductor with an insulation coating;
thereafter forming a low-flatness portion by applying a force to the insulated electric wire from outside to inside in a width direction of the flat outer shape in a partial region along an axial direction of the insulated electric wire to reduce the degree of flatness of the conductor; and
leaving a region other than the partial region formed into the low-flatness portion as a flat portion.

10. A wiring harness, comprising the insulated electric wire according to claim 1.

11. A method for manufacturing an insulated electric wire, comprising the steps of:
making an insulated electric wire by compressing a conductor in which a plurality of elemental wires are twisted together into a flat outer shape and by covering an outer periphery of the conductor with an insulation coating;
thereafter forming a low-flatness portion by applying a force to the insulated electric wire from outside to inside in a width direction of the flat outer shape in a partial region along an axial direction of the insulated electric wire to reduce the degree of flatness of the conductor; and
leaving a region other than the partial region formed into the low-flatness portion as a flat portion.
